(19) United States
(12) Patent Application Publication
(10) Pub. No.: US 2026/0118710 A1
(43) Pub. Date: Apr. 30, 2026

(54) Display Device Having a Narrow Bezel Design with Optimized Viewing Angle

(71) Applicant: Dell Products L.P., Round Rock, TX (US)

(72) Inventors: Guentaek Oh, Singapore (SG); SeongYong Kim, Singapore (SG); KyungEun Lee, Singapore (SG)

(21) Appl. No.: 18/928,504

(22) Filed: Oct. 28, 2024

(51) Int. Cl. G02F 1/1333; G02F 1/1335

(52) U.S. Cl. CPC G02F 1/133322; G02F 1/133528

(57) ABSTRACT

A display device which includes an optical sheets component and a viewing angle optimization system. The viewing angle optimization system includes a display cell component and an elastomeric panel component, the elastomeric panel component extending around a peripheral edge of the display cell component, the elastomeric panel component restricting optical sheets of the display device.

### BACKGROUND OF THE INVENTION

### Field of the Invention

The present invention relates to information handling systems. More specifically, embodiments of the invention relate to information handling system display devices.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

An information handling system display device which includes a viewing angle optimization system is disclosed.

More specifically, in one embodiment the invention relates to a viewing angle optimization system for a display device comprising: a display cell component; and, an elastomeric panel component, the elastomeric panel component extending around a peripheral edge of the display cell component, the elastomeric panel component restricting optical sheets of the display device.

In another embodiment the invention relates to a display device comprising an optical sheets component; and, a viewing angle optimization system, the viewing angle optimization system comprising: a display cell component; and, an elastomeric panel component, the elastomeric panel component extending around a peripheral edge of the display cell component, the elastomeric panel component restricting optical sheets of the display device.

In another embodiment the invention relates to a system comprising: a processor; a data bus coupled to the processor; and a display device comprising an optical sheets component; and, a viewing angle optimization system, the viewing angle optimization system comprising: a display cell component; and, an elastomeric panel component, the elastomeric panel component extending around a peripheral edge of the display cell component, the elastomeric panel component restricting optical sheets of the display device.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows a cross sectional view of a portion of a display device.

FIG. 2 shows a general illustration of components of an information handling system as implemented in the present disclosure.

FIG. 3 shows a block diagram of an information handling system configuration and fabrication environment.

FIG. 4 shows a front view of a display device.

FIGS. 5A and 5B, generally referred to as FIG. 5, respectively show a corner view of a portion of a display device and a cross sectional view of a portion of a display device.

FIG. 6 shows an exploded view of a plurality of components of a display device.

FIGS. 7A, 7B and 7C, generally referred to as FIG. 7, show a plurality of views of a display device panel.

FIG. 8 shows a cross sectional view of a portion of a display device.

### DETAILED DESCRIPTION

Certain aspects of the disclosure reflect an appreciation it is desirable to information handling system display devices with a narrow bezel. Certain aspects of the disclosure reflect an appreciation information handling system display device designs have significantly narrowed their bezel width over subsequent designs. Certain aspects of the disclosure reflect an appreciation that many known information handling system display device panel designs include one or more display device optical components such as a display device light guide plate (LGP).

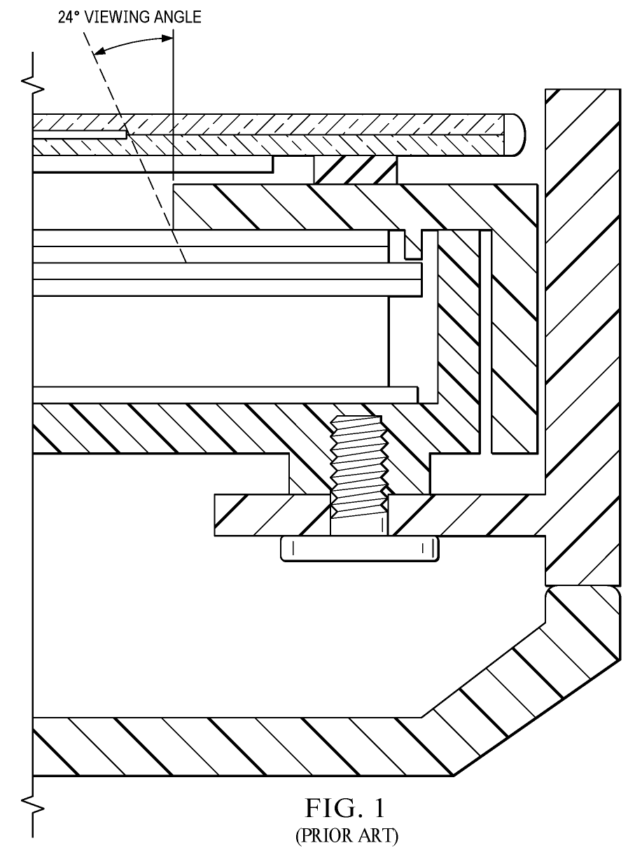

Certain aspects of the present disclosure include an appreciation that many known narrow bezel display devices include an internal frame to which a display device panel is attached. Certain aspects of the present disclosure include an appreciation that this internal frame also often restricts optical sheets of the display device along a z axis of the display device. Certain aspects of the disclosure reflect an appreciation that known narrow bezel display device designs can often present image quality issues. Certain aspects of the disclosure include an appreciation that these image quality issues are often a result of a restricted viewing angle (i.e., an angle away from a perpendicular line that an edge of the optical components can be observed). Certain aspects of the present disclosure include an appreciation that the restricted viewing angle can often be a viewing angle of substantially (i.e., +/- 20%) 24 degrees. Certain aspects of the present disclosure include an appreciation that one contributor to the restricted viewing angle is the internal frame of the narrow bezel display device. For example, FIG. 1, labeled Prior Art, shows a cross section of portion of a known display device which includes such a restricted viewing angle.

Certain aspects of the present disclosure include an appreciation that certain parts of a display device frame may be observed at specific viewing angles. Certain aspects of the present disclosure include an appreciation that certain parts of a display device frame may be even more easily observed with narrow bezel display device designs. Certain aspects of the present disclosure include an appreciation that a display device frame which is easily detected may be needed to restrict a display device optical sheet along a z axis. For example, FIG. 1, labeled Prior Art, shows a cross section of a portion of a known display device which includes such a display device frame.

Certain aspects of the disclosure reflect an appreciation that with known narrow bezel designs, beyond a certain viewing angle, the user can observe a darkened area along an edge of the display device screen. This phenomenon is often referred to as a shadow effect. Certain aspects of the disclosure reflect an appreciation that the shadow effect can present display device image issues such as a shadowed edge along one or more sides of the display device, a disappearing cursor along one or more sides of the display device, or a combination thereof.

Accordingly, a system and method are disclosed for providing an information handling system display device with a display device viewing angle optimization system. In certain embodiments, the display device viewing angle optimization system performs a display device viewing angle optimization operation. In certain embodiments, the display device viewing angle optimization system maximizes a viewing angle of the display device.

In certain embodiments, the display device viewing angle optimization system implements a display device panel which includes an elastomeric panel component. In certain embodiments, the elastomeric panel component includes an elastic resin. In certain embodiments, the elastic resin is substantially (i.e., +/- 20% transparent). In certain embodiments, the elastomeric panel component extends around a peripheral edge of the display device panel. In certain embodiments, the peripheral edge is located within 0.5 mm (+/-20%) of an outside edge of the display device panel. In certain embodiments, the elastomeric panel component extends along the top side outside edge, the bottom side outside edge, the right side outside edge, the left side outside edge, or a combination thereof, of the display device panel.

In certain embodiments, the elastomeric panel component restricts optical sheets of the display device. In certain embodiments, the elastomeric panel component restricts optical sheets of the display device along a z axis of the display device. In certain embodiments, the elastomeric panel component is dispensed on the display device panel using side sealing dispensing equipment.

In certain embodiments, the display device viewing angle optimization system allows a display device frame to be located at the side of the optical sheets of the display device as compared with previous designs where the frame is located on top of the optical sheets. In certain embodiments, the display device viewing angle optimization system maximizes the viewing angle of narrow bezel display devices without creating a shadow effect even.

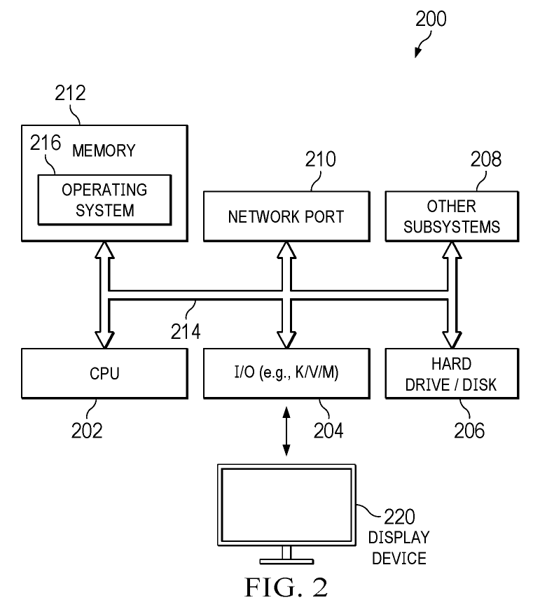

FIG. 2 is a generalized illustration of an information handling system 200 that can be used to implement the system and method of the present invention. The information handling system 200 includes a processor (e.g., central processor unit or “CPU”) 202, input/output (I/O) devices 204, such as a display, a keyboard, a mouse, a touchpad or touchscreen, and associated controllers, a hard drive or disk storage 206, and various other subsystems 208. In various embodiments, the information handling system 200 also includes network port 210 operable to connect to a network 240, which is likewise accessible by a service provider server 242. The information handling system 200 likewise includes system memory 212, which is interconnected to the foregoing via one or more buses 214. System memory 212 further comprises operating system (OS) 216. In various embodiments, the information handling system 200 is coupled with and communicates with a display device 220. In various embodiments, the information handling system is integrated with the display device to provide an all in one (AIO) type information handling system. In certain embodiments, the information handling system includes a portable information handling system which includes an integrated display device.

In certain embodiments, the display device 220 includes a display device viewing angle optimization system. In certain embodiments, the display device viewing angle optimization system performs a display device viewing angle optimization operation. In certain embodiments, the display device viewing angle optimization system maximizes a viewing angle of the display device.

In certain embodiments, the display device viewing angle optimization system implements a display device panel which includes an elastomeric panel component. In certain embodiments, the elastomeric panel component includes an elastic resin. In certain embodiments, the elastic resin is substantially (i.e., +/- 20% transparent). In certain embodiments, the elastomeric panel component extends around a peripheral edge of the display device panel. In certain embodiments, the peripheral edge is located within 0.5 mm (+/-20%) of an outside edge of the display device panel. In certain embodiments, the elastomeric panel component extends along the top side outside edge, the bottom side outside edge, the right side outside edge, the left side outside edge, or a combination thereof, of the display device panel.

In certain embodiments, the elastomeric panel component restricts optical sheets of the display device. In certain embodiments, the elastomeric panel component restricts optical sheets of the display device along a z axis of the display device. In certain embodiments, the elastomeric panel component is dispensed on the display device panel using side sealing dispensing equipment.

In certain embodiments, the display device viewing angle optimization system allows a display device frame to be located at the side of the optical sheets of the display device as compared with previous designs where the frame is located on top of the optical sheets. In certain embodiments, the display device viewing angle optimization system maximizes the viewing angle of narrow bezel display devices without creating a shadow effect even.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

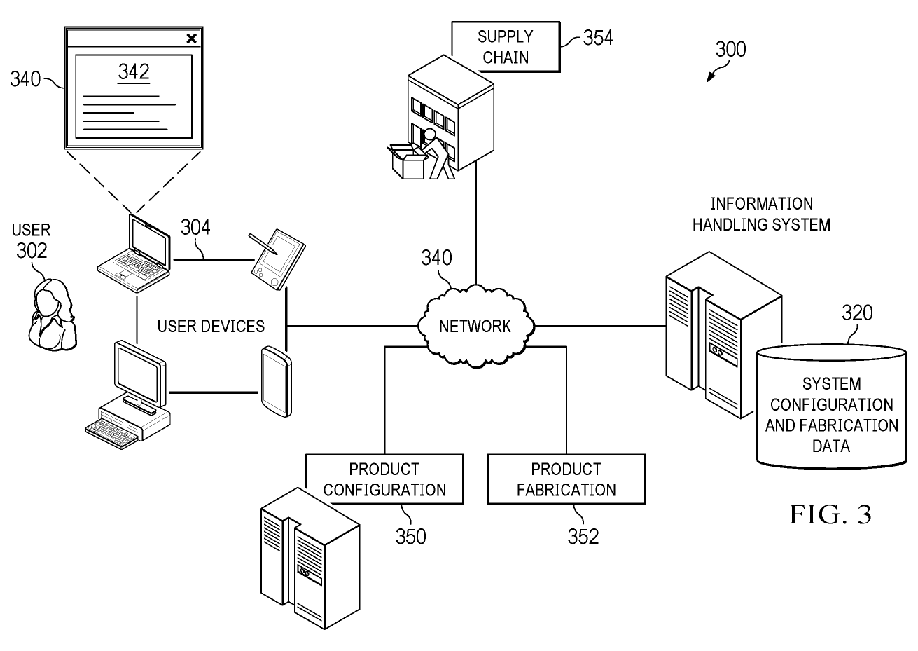

FIG. 3 is a block diagram of an information handling system configuration and fabrication environment 300 implemented in accordance with an embodiment of the invention. In certain embodiments, the information handling system configuration and fabrication environment 300 may include a repository of information handling system configuration and fabrication data 320. In certain embodiments, the repository of information handling system configuration and fabrication data 320 may be local or may be executed remotely.

In certain embodiments, the user device 304 is used to exchange information between the user 302 and a product configuration system 350, and a custom product fabrication system 350, through the use of a network 340. In certain embodiments, the network 340 may be a public network, such as a public internet protocol (IP) network, a physical private network, a wireless network, a virtual private network (VPN), or any combination thereof. Skilled practitioners of the art will recognize that many such embodiments are possible, and the foregoing is not intended to limit the spirit, scope or intent of the invention. As used herein, a user device 304 refers to an information handling system such as a personal computer, a laptop computer, a tablet computer, a personal digital assistant (PDA), a smart phone, a mobile telephone, or other device that is capable of communicating and processing data. In certain embodiments, the user device 304 may be configured to present a configuration and/or fabrication system user interface (UI) 340. In certain embodiments, the configuration and/or fabrication system UI 340 may be implemented to present a graphical representation 342 of configuration and/or fabrication information.

In various embodiments, the configuration and/or fabrication system UI 340 may be presented via a website. In certain embodiments, the website may be provided by the product configuration system 350. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

In certain embodiments, the user device 304 may be implemented to interact with the product configuration system 350, which in turn may be executing on a separate information handling system 300. In various embodiments, the product configuration system 350 interacts with a custom product fabrication system 352. In various embodiments, the custom product fabrication system 352 fabricates products. In various embodiments, the fabricated product includes a display device. In various embodiments, the display device includes a display device viewing angle optimization system.

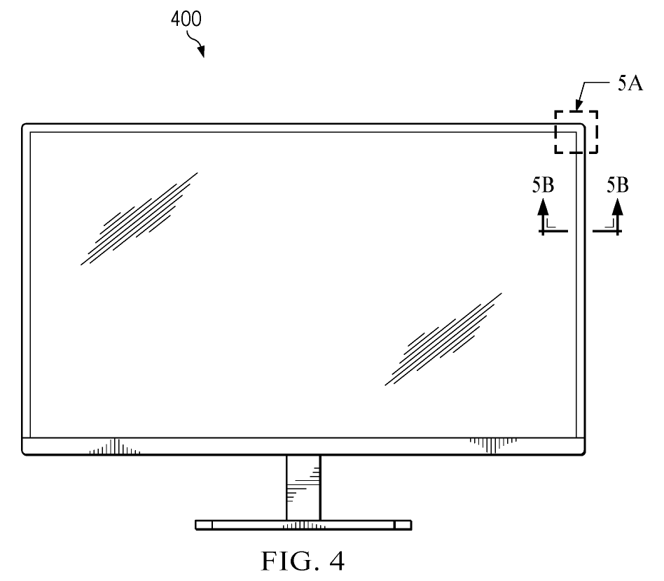

FIG. 4 shows a front view of a display device 400. In certain embodiments, the display device 400 corresponds to display device 220. In certain embodiments, the display device 400 includes a display device viewing angle optimization system.

In certain embodiments, the display device viewing angle optimization system performs a display device viewing angle optimization operation. In certain embodiments, the display device viewing angle optimization system maximizes a viewing angle of the display device.

In certain embodiments, the display device viewing angle optimization system implements a display device panel which includes an elastomeric panel component. In certain embodiments, the elastomeric panel component includes an elastic resin. In certain embodiments, the elastic resin is substantially (i.e., +/- 20% transparent). In certain embodiments, the elastomeric panel component extends around a peripheral edge of the display device panel. In certain embodiments, the peripheral edge is located within 0.5 mm (+/-20%) of an outside edge of the display device panel. In certain embodiments, the elastomeric panel component extends along the top side outside edge, the bottom side outside edge, the right side outside edge, the left side outside edge, or a combination thereof, of the display device panel.

In certain embodiments, the elastomeric panel component restricts optical sheets of the display device. In certain embodiments, the elastomeric panel component restricts optical sheets of the display device along a z axis of the display device. In certain embodiments, the elastomeric panel component is dispensed on the display device panel using side sealing dispensing equipment.

In certain embodiments, the display device viewing angle optimization system allows a display device frame to be located at the side of the optical sheets of the display device as compared with previous designs where the frame is located on top of the optical sheets. In certain embodiments, the display device viewing angle optimization system maximizes the viewing angle of narrow bezel display devices without creating a shadow effect even.

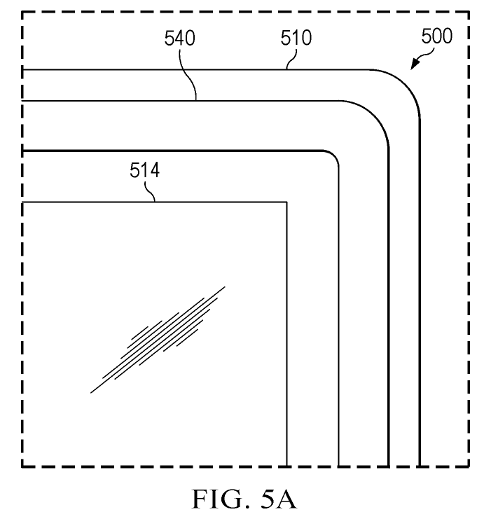

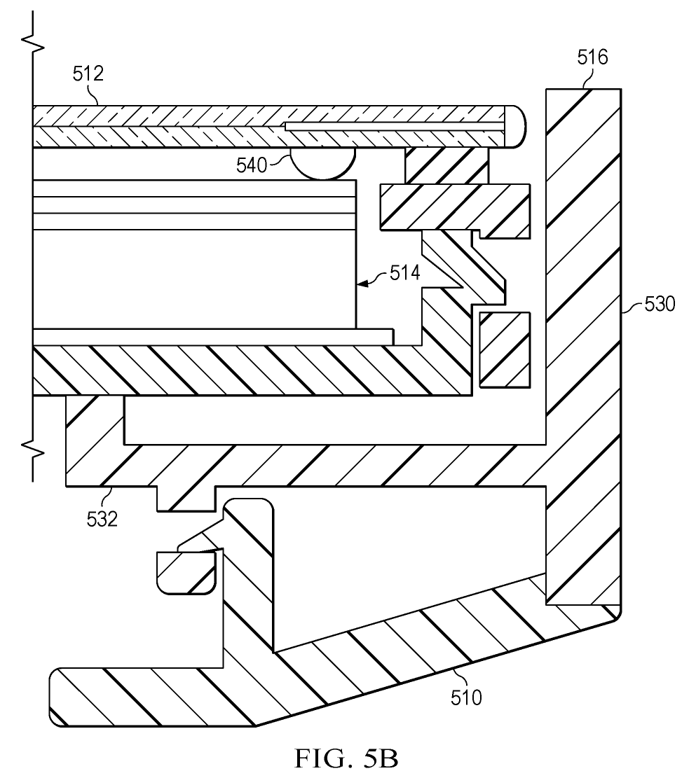

FIGS. 5A and 5B, generally referred to as FIG. 5, respectively show a corner view of a portion of a display device 500 and a cross sectional view of a portion of a display device 500. In certain embodiments, the display device 500 corresponds to display device 400. In certain embodiments, the display device 500 includes a display device viewing angle optimization system. In certain embodiments, the display device viewing angle optimization system performs a display device viewing angle optimization operation.

In certain embodiments, the display device 500 includes a rear frame portion 510, an open cell LCD component 512, an optical sheets component 514, a middle frame component 516 and a system frame mounting component 518. In certain embodiments, the middle frame component 516 includes an integrated mold frame. In certain embodiments, the middle frame 516 is configured to physically mate with the rear frame portion 510. In certain embodiments, the middle frame component 516 includes an exterior edge portion 530 and an optical sheets support portion 532. In certain embodiments, the exterior edge portion 530 extends substantially (i.e., +/- 20%) perpendicularly to the optical sheets support portion 532. In certain embodiments, the exterior edge portion 530 extends along a side edge of the outside of the display device 700. In certain embodiments, the optical sheets support portion 532 extends along a side edge of the inside of display device 500. In certain embodiments, the optical sheets support portion 532 is contiguous with an edge of the optical sheets component 514. In certain embodiments, the LCD component 512 corresponds to the display panel of display device 400.

In certain embodiments, the display device 500 includes an elastomeric panel component 540. In certain embodiments, the elastomeric panel component 540 includes an elastic resin. In certain embodiments, the elastic resin is substantially (i.e., +/- 20% transparent). In certain embodiments, the elastomeric panel component 540 extends around a peripheral edge of the LCD component 512. In certain embodiments, the peripheral edge is located within 0.5 mm (+/-20%) of an outside edge of the LCD component 512. In certain embodiments, the elastomeric panel component 540 extends along the top side outside edge, the bottom side outside edge, the right side outside edge, the left side outside edge, or a combination thereof, of the LCD component 540.

In certain embodiments, the elastomeric panel component 540 restricts the optical sheets component 514. In certain embodiments, the elastomeric panel component restricts the optical sheets component 514 along a z axis of the display device 500.

In certain embodiments, the display device viewing angle optimization system allows a display device middle frame 516 to be located at the side of the optical sheets component 514 as compared with previous designs where a portion of the frame is located on top of the optical sheets component. In certain embodiments, the display device viewing angle optimization system maximizes the viewing angle of narrow bezel display devices without creating a shadow effect even. In certain embodiments, the display device viewing angle optimization system includes the LCD component 512, the middle frame 516 and the elastomeric panel component 540.

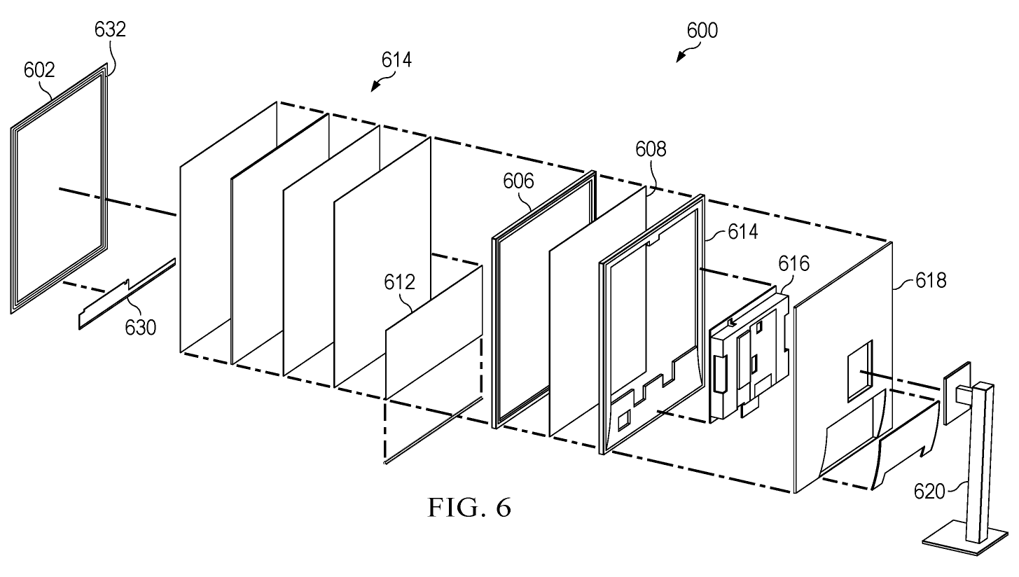

FIG. 6 shows an exploded view of a plurality of components of a display device 600. In certain embodiments, the display device 600 includes an open-cell LCD component 602, an optical sheets component which includes one or more optical sheets 604, a panel support component 606, a light guide panel 608, a bottom frame 610, a shield component 612, a middle frame 614, a control board portion 616 and a rear cover 618. In certain embodiments, the display device 600 also includes a stand 620 which optionally mounts with the rear cover 618. In certain embodiments, the display device 600 further includes a bottom trim portion 630, an elastomeric panel component 632, or a combination thereof.

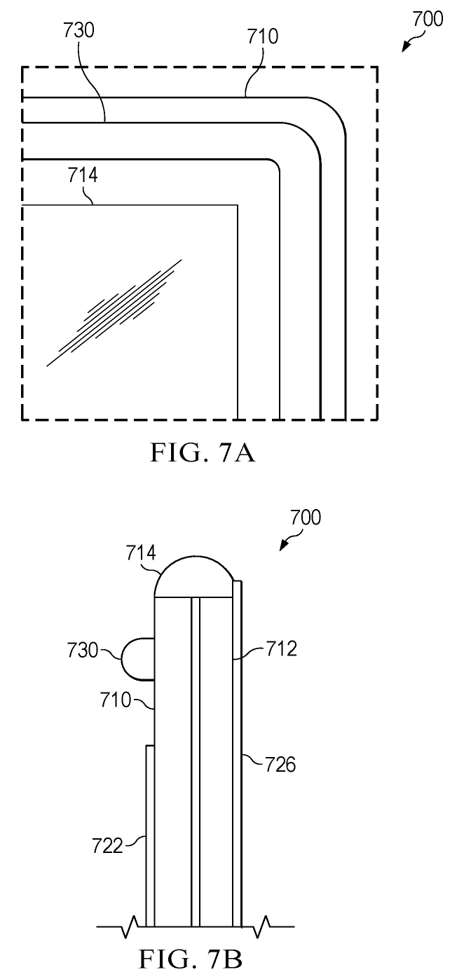

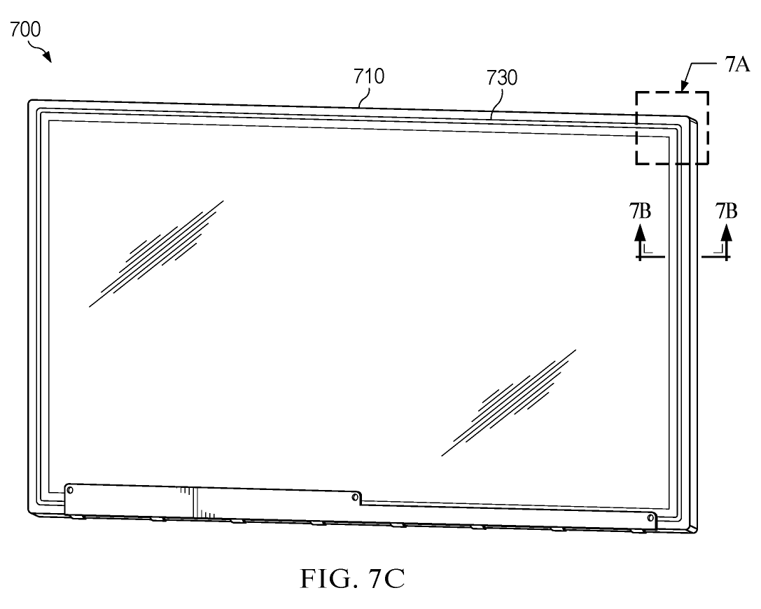

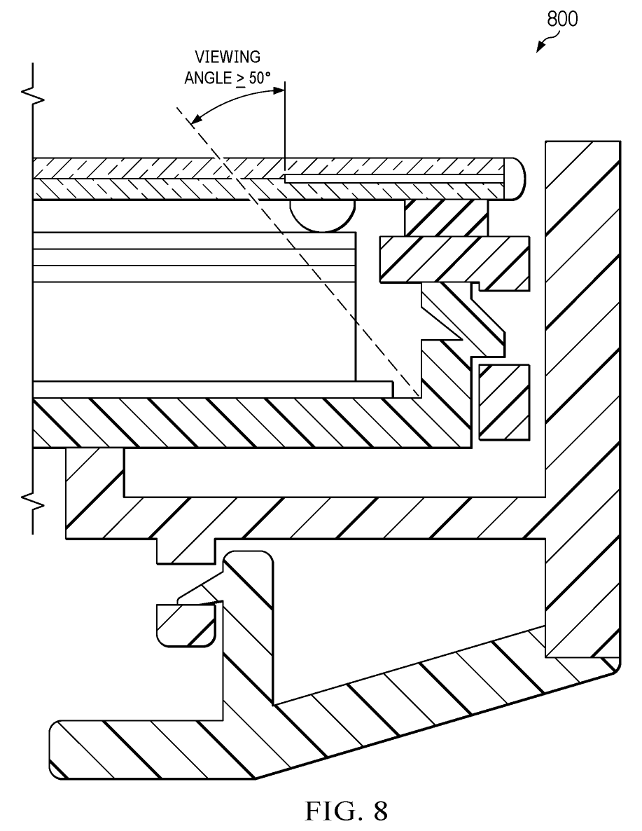

FIGS. 7A, 7B and 7C, generally referred to as FIG. 7, show a plurality of views of a display device panel 700. In certain embodiments, the display device panel 700 corresponds to the display device panel of display device 400.

In certain embodiments, the display device panel 700 includes a color filter (CF) glass component 710, a thin film transistor (TFT) glass component 712, a sealing component 714, or a combination thereof. In certain embodiments, the device panel includes a front polarizer component 720, a rear polarizer component 722, or a combination thereof. In certain embodiments, the display device panel includes an elastomeric panel component 730.

In certain embodiments, the sealing component 714 extends along an edge of the display device panel 700. In certain embodiments, the sealing component 714 extends around a peripheral edge of the display device panel. In certain embodiments, the sealing component 714 extends around a peripheral edge of the color filter glass component 710, the thin film transistor component 712, or a combination thereof.

In certain embodiments, the front polarizer component 720 is larger than the rear polarizer component 722. In certain embodiments, the front polarizer component 720 extends substantially (i.e., +/- 20%) to an outside edge of the display device panel 700. In certain embodiments, the front polarizer component 720 extends to a peripheral edge of the display device panel. In certain embodiments, the front polarizer component 720 is wider than, taller than, or a combination thereof, the rear polarizer component 722. In certain embodiments, an edge of the front polarizer component 720 overlaps with a portion of the sealing component 714.

In certain embodiments, the elastomeric panel component 730 includes an elastic resin. In certain embodiments, the elastic resin is substantially (i.e., +/- 20% transparent). In certain embodiments, the elastomeric panel component 730 extends around a peripheral edge of the display device panel. In certain embodiments, the peripheral edge is located within 0.5 mm (+/-20%) of an outside edge of the display device panel 700. In certain embodiments, the elastomeric panel component 730 extends along the top side outside edge, the bottom side outside edge, the right side outside edge, the left side outside edge, or a combination thereof, of the display device panel 700.

In certain embodiments, the elastomeric panel component 730 extends along an inside surface of the display device panel 700. In certain embodiments, the elastomeric panel component 730 is positioned opposite to the portion of the front polarizer component 720 that is larger than the rear polarizer component 722.

FIG. 8 shows a cross sectional view of a portion of a display device 800. In certain embodiments, display device 800 corresponds to display device 400. In certain embodiments, the display device 800 includes a display device viewing angle optimization system which maximizes a viewing angle of the display device. In certain embodiments, the display device 800 includes display device viewing angle optimization system which provides narrow bezel display device with a viewing angle (i.e., an angle away from a perpendicular line that an edge of the optical components can be observed) of substantially (+/- 20%) 50 degrees.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A viewing angle optimization system for a display device comprising:
a display cell component; and,
an elastomeric panel component, the elastomeric panel component extending around a peripheral edge of the display cell component, the elastomeric panel component restricting optical sheets of the display device.

2. The viewing angle optimization system of claim 1, wherein:
the elastomeric panel component includes an elastic resin.

3. The viewing angle optimization system of claim 1, wherein:
the elastomeric panel component is substantially transparent.

4. The viewing angle optimization system of claim 1, wherein:
the elastomeric panel component restricts the optical sheets of the display device along a z axis of the display device.

5. The viewing angle optimization system of claim 1, wherein:
the elastomeric panel component extends along an inside surface of the display cell component.

6. The viewing angle optimization system of claim 5, wherein:
the display cell component includes a front polarizer component and a rear polarizer component, the front polarizer component being larger than the rear polarizer component; and,
the elastomeric panel component extends along an inside surface of the display cell component opposite to a larger portion of front polarizer component.

7. A display device comprising:
an optical sheets component; and,
a viewing angle optimization system, the viewing angle optimization system comprising
a display cell component; and,
an elastomeric panel component, the elastomeric panel component extending around a peripheral edge of the display cell component, the elastomeric panel component restricting optical sheets of the display device.

8. The display device of claim 7, wherein:
the elastomeric panel component includes an elastic resin.

9. The display device of claim 7, wherein:
the elastomeric panel component is substantially transparent.

10. The display device of claim 7, wherein:
the elastomeric panel component restricts the optical sheets component device along a z axis of the display device.

11. The display device of claim 7, wherein:
the elastomeric panel component extends along an inside surface of the display cell component.

12. The display device of claim 11, wherein:
the display cell component includes a front polarizer component and a rear polarizer component, the front polarizer component being larger than the rear polarizer component; and,
the elastomeric panel component extends along an inside surface of the display cell component opposite to a larger portion of front polarizer component.

13. A system comprising:
a processor;
a data bus coupled to the processor; and
a display device comprising
an optical sheets component; and,
a viewing angle optimization system, the viewing angle optimization system comprising
a display cell component; and,
an elastomeric panel component, the elastomeric panel component extending around a peripheral edge of the display cell component, the elastomeric panel component restricting optical sheets of the display device.

14. The system of claim 13, wherein:
the elastomeric panel component includes an elastic resin.

15. The system of claim 13, wherein:
the elastomeric panel component is substantially transparent.

16. The system of claim 13, wherein:
the elastomeric panel component restricts the optical sheets component device along a z axis of the display device.

17. The system of claim 13, wherein:
the elastomeric panel component extends along an inside surface of the display cell component.

18. The system of claim 17, wherein:
the display cell component includes a front polarizer component and a rear polarizer component, the front polarizer component being larger than the rear polarizer component; and,
the elastomeric panel component extends along an inside surface of the display cell component opposite to a larger portion of front polarizer component.
